(19) United States
(12) Patent Application Publication
(10) Pub. No.: US 2009/0119153 A1
(43) Pub. Date: May 7, 2009

(54) TOOLS AND METHODS FOR BRAND STRATEGY DEVELOPMENT

(75) Inventor: Jeffrey A. Cameron, Carrollton, TX (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: FREEMAN CAPITAL COMPANY, Las Vegas, NV (US)

(21) Appl. No.: 11/935,836

(22) Filed: Nov. 6, 2007

(51) Int. Cl. G06Q 30/00

(52) U.S. Cl. 705/10

(57) ABSTRACT

A tool is provided for use in connection with development of a brand essence. The tool includes a plurality of subsets of descriptor cards. Each subset of descriptor cards has a first set of indicia relating to an associated human sense on a first side of each descriptor card and a second set of indicia relating to the associated human sense on a second side of each descriptor card. The subsets of descriptor cards are based on a plurality of theme categories common to each subset. The first set of indicia on each descriptor card includes a theme category, at least one example associated with the theme category and relating to the associated human sense, at least one descriptor associated with each example, and at least one image associated with the example. The second set of indicia on each descriptor card includes the example on the first side of the descriptor card and the image on the first side of the descriptor card.

### TECHNICAL FIELD

The present invention relates generally to the field of brand strategy. In particular, the present invention relates to tools and methods for developing a brand strategy.

### BACKGROUND

The ability of a business to effectively communicate its overall essence or message to its customers can be critical to the success of the business. When developing a marketing strategy, businesses often create a brand essence or personality, such as a brand image, tone and voice, which represents the brand. The brand's essence can be used as a tool to capture the attention of a business's customer. Once created, the business may utilize the brand's essence throughout all avenues of advertising for a more integrated advertising approach. For example, brand essence may be integrated into its website, pamphlets, or trade show booths. Thus, properly developing the brand essence of a business is important for successful marketing.

The development of a business's brand culture often includes determining the characteristics that the business would like to convey to its customers and to have its customers experience. Conventionally, businesses may choose or define their brand description with the aid of a storyboard, look book or a comp board. Purposes of the storyboards include providing an outline of the design approach, defining the necessary elements, and showing how the elements will work together to provide a particular experience. Essentially, the storyboard allows a user to pre-visualize the advertising media. In the advertising industry, storyboards may include visual impressions of color and texture that are cut out and placed on a board. After the user chooses which colors and textures that he or she feels represents the business, a visual analysis of the preferences is performed and a brand or marketing strategy is developed for the business.

While using storyboards may be effective at determining the personal preference of the person selecting the colors and textures, it may not adequately convey the actual brand essence of the business. Therefore, there is a need in the art for a system that facilitates proper development of a business's brand essence or culture.

### SUMMARY

A tool is provided for use in connection with development of a brand essence. The tool includes a plurality of subsets of descriptor cards. Each subset of descriptor cards has a first set of indicia relating to an associated human sense on a first side of each descriptor card and a second set of indicia relating to the associated human sense on a second side of each descriptor card. The subsets of descriptor cards are based on a plurality of theme categories common to each subset. The first set of indicia on each descriptor card includes a theme category, at least one example associated with the theme category and relating to the associated human sense, at least one descriptor associated with each example, and at least one image associated with the example. The second set of indicia on each descriptor card includes the example on the first side of the descriptor card and the image on the first side of the descriptor card.

A method of using the tool to develop a brand strategy is also provided.

### BRIEF DESCRIPTION OF THE DRAWINGS

FIG. 1 is a front view of an exemplary set of sensory cards.

FIG. 2A is a front view of an exemplary embodiment of a first sense subset.

FIG. 2B is a front view of an exemplary embodiment of a second sense subset.

FIG. 2C is a front view of an exemplary embodiment of a third sense subset.

FIG. 2D is a front view of an exemplary embodiment of a fourth sense subset.

FIG. 2E is a front view of an exemplary embodiment of a fifth sense subset.

FIG. 3A is a front view of an exemplary identifier card.

FIG. 3B is a rear view of the exemplary identifier card.

FIG. 4A is a front view of exemplary identifier cards of the first, second, third, fourth, and fifth subsets.

FIG. 4B is a rear view of exemplary identifier cards of the first, second, third, fourth, and fifth subsets.

FIG. 5A a front view of an exemplary descriptor card.

FIG. 5B is a rear view of the exemplary descriptor card.

FIG. 6A is a front view of exemplary descriptor cards of the first sense subset.

FIG. 6B is a rear view of exemplary descriptor cards of the first sense subset.

FIG. 7A is a front view of exemplary descriptor cards of the second sense subset.

FIG. 7B is a rear view of exemplary descriptor cards of the second sense subset.

FIG. 8A a front view of exemplary descriptor cards of the third sense subset.

FIG. 8B is a rear view of exemplary descriptor cards of the third sense subset.

FIG. 9A a front view of exemplary descriptor cards of the fourth sense subset.

FIG. 9B is a rear view of exemplary descriptor cards of the fourth sense subset.

FIG. 10A a front view of exemplary descriptor cards of the fifth sense subset.

FIG. 10B is a rear view of exemplary descriptor cards of the fifth sense subset.

FIG. 11 is a front view of the first, second, third, fourth, and fifth sense subsets.

FIG. 12 is a diagram of a method of designing a brand strategy using the set of sensory cards.

### DETAILED DESCRIPTION

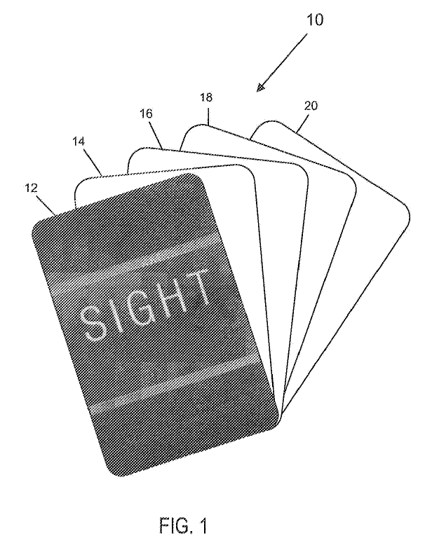

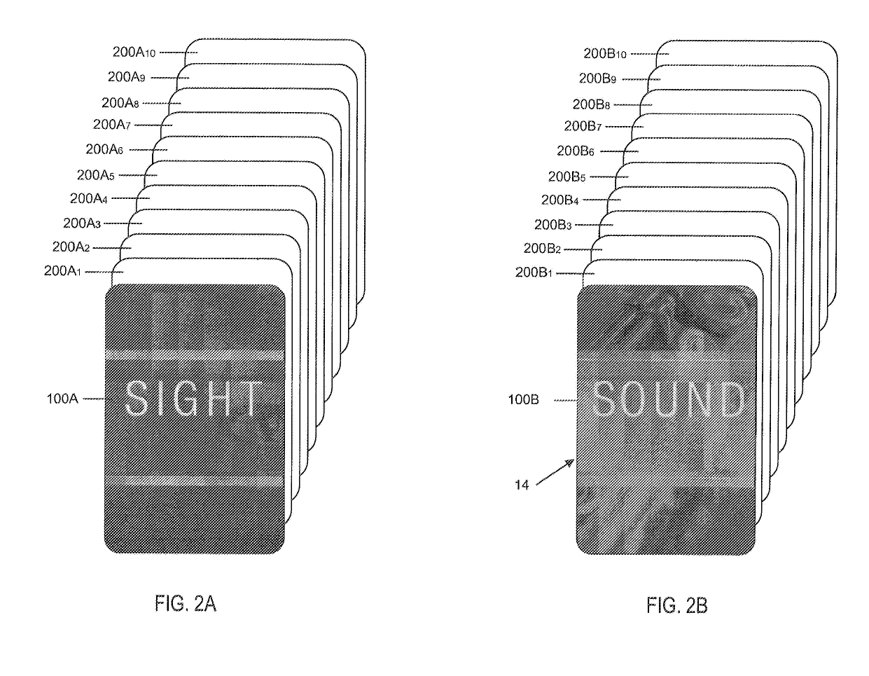

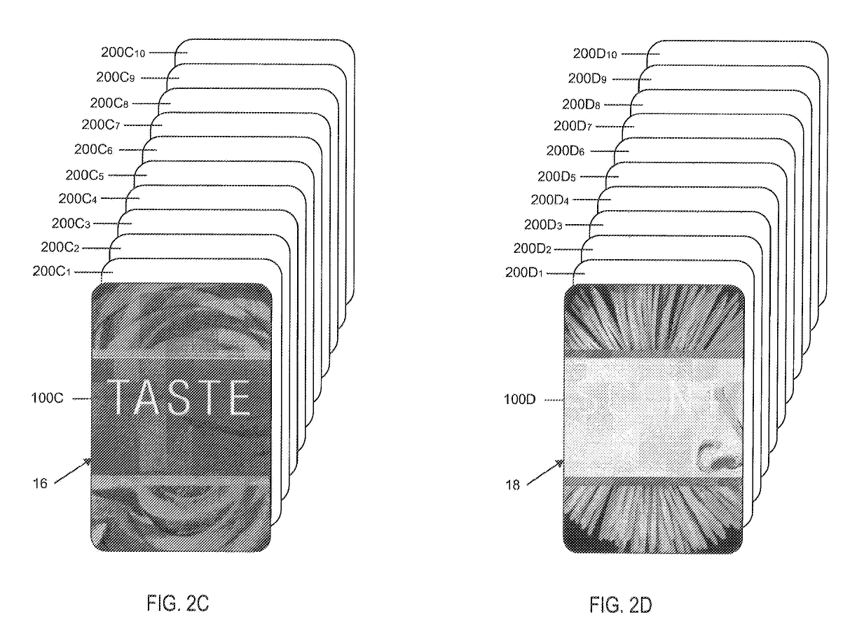

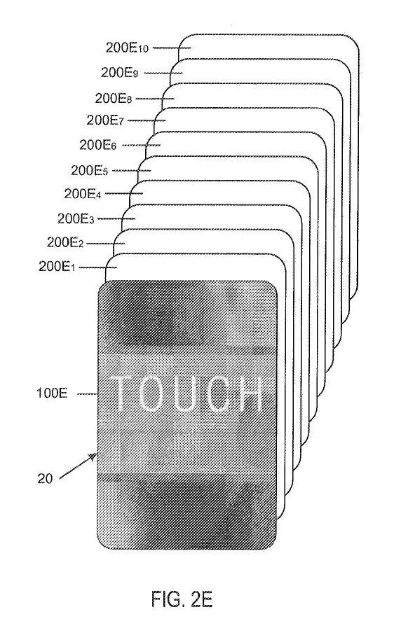

FIG. 1 is a front view of an exemplary set of sensory cards 10 that can be used as a tool in accordance with the present invention for developing a brand strategy for a business. Set of sensory cards 10 generally includes a first sense subset 12, a second sense subset 14, a third sense subset 16, a fourth sense subset 18, and a fifth sense subset 20. FIGS. 2A, 2B, 2C, 2D, and 2E are front views of particular embodiments of first sense subset 12, second sense subset 14, third sense subset 16, fourth sense subset 18, and fifth sense subset 20 and will be discussed in conjunction with FIG. 1. Each sense subset 12, 14, 16, 18, and 20 is associated with a particular human sense: sight, sound, taste, scent, or touch. In an exemplary embodiment that will be used throughout the body of this specification, first sense subset 12 is associated with sight, second sense subset 14 is associated with sound, third sense subset 16 is associated with taste, fourth sense subset 18 is associated with scent, and fifth sense subset 20 is associated with touch. However, each sense subset 12-20 may be associated with any of the five human senses without departing from the intended scope of the invention. Set of sensory cards 10 directs the user to focus on the five human senses to determine the characteristics of the brand that he or she is attempting to market or advertise. Set of sensory cards 10 thus provides a tool that is directed towards all five of the human senses, allowing for a more comprehensive exploration of the senses. By using set of sensory cards 10, along with information gained from conversations with the user, an accurate brand portrait may be obtained.

Each sense subset 12, 14, 16, 18, and 20 includes an identifier card 100 and a plurality of descriptor cards 200. Identifier card 100 is positioned at the beginning of each sense subset 12-20 to identify the human sense associated with each particular sense subset 12-20. First sense subset 12 includes identifier card 100A and descriptor cards 200A₁, 200A₂, 200A₃, 200A₄, 200A₅, 200A₆, 200A₇, 200A₈, 200A₉, and 200A₁₀. Second sense subset 14 includes identifier card 100B and descriptor cards 200B₁, 200B₂, 200B₃, 200B₄, 200B₅, 200B₆, 200B₇, 200B₈, 200B₉, and 200B₁₀. Third sense subset 16 includes identifier card 100C and descriptor cards 200C₁, 200C₂, 200C₃, 200C₄, 200C₅, 200C₆, 200C₇, 200C₈, 200C₉, and 200C₁₀. Fourth sense subset 18 includes identifier card 100D and descriptor cards 200D₁, 200D₂, 200D₃, 200D₄, 200D₅, 200D₆, 200D₇, 200D₈, 200D₉, and 200D₁₀. Fifth sense subset 20 includes identifier card 100E and descriptor cards 200E₁, 200E₂, 200E₃, 200E₄, 200E₅, 200E₆, 200E₇, 200E₈, 200E₉, and 200E₁₀. Although sense subsets 12-20 are discussed and depicted as including one identifier card and ten descriptor cards, each of sense subsets 12-20 may include any number of cards without departing from the intended scope of the present invention.

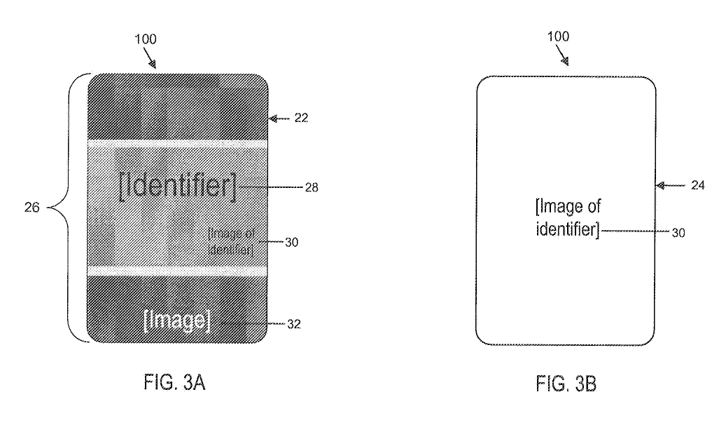

FIGS. 3A and 3B show a front view and a rear view, respectively, of an exemplary identifier card 100. Each identifier card 100 has a front side 22 and a rear side 24. Front side 22 of identifier card 100 includes indicia 26 related to the human sense associated with the respective sense subset 12-20. In the embodiment shown, indicia 26 includes a word identifier 28, an image 30 of the portion of the body that is associated with, or evocative of, the human sense, and an image 32 associated with identifier 28. Identifier 28 references the human sense associated with the respective sense subset 12-20. Rear side 24 of identifier card 100 includes image 30 of the portion of the body that is associated with the human sense of the respective sense subset 12-20 in the illustrated embodiment.

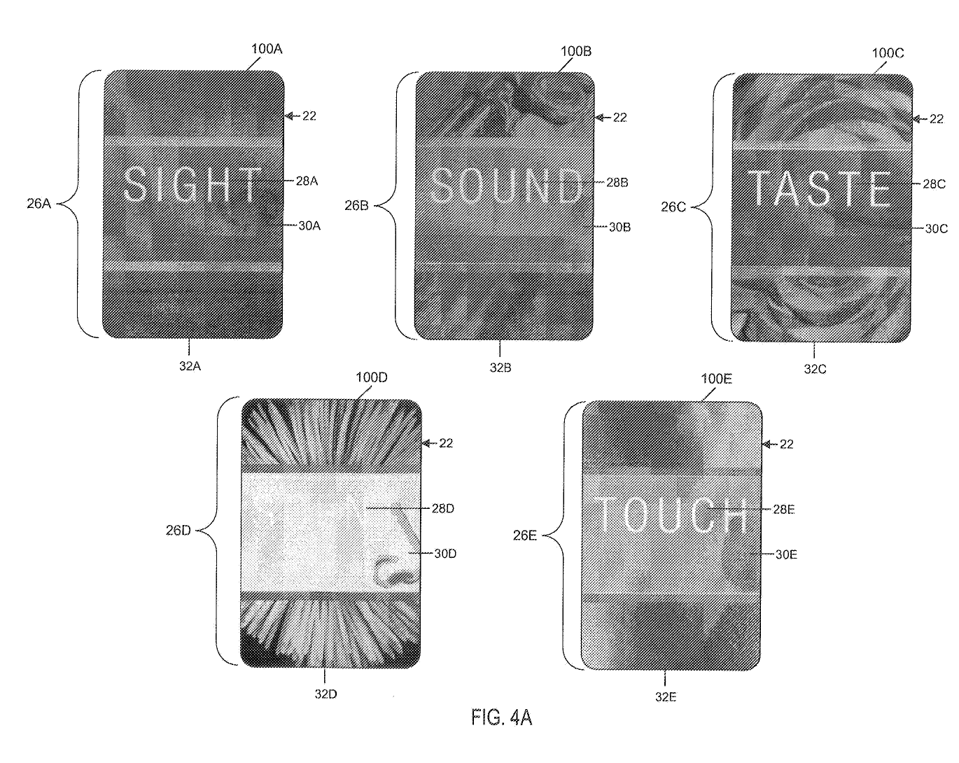

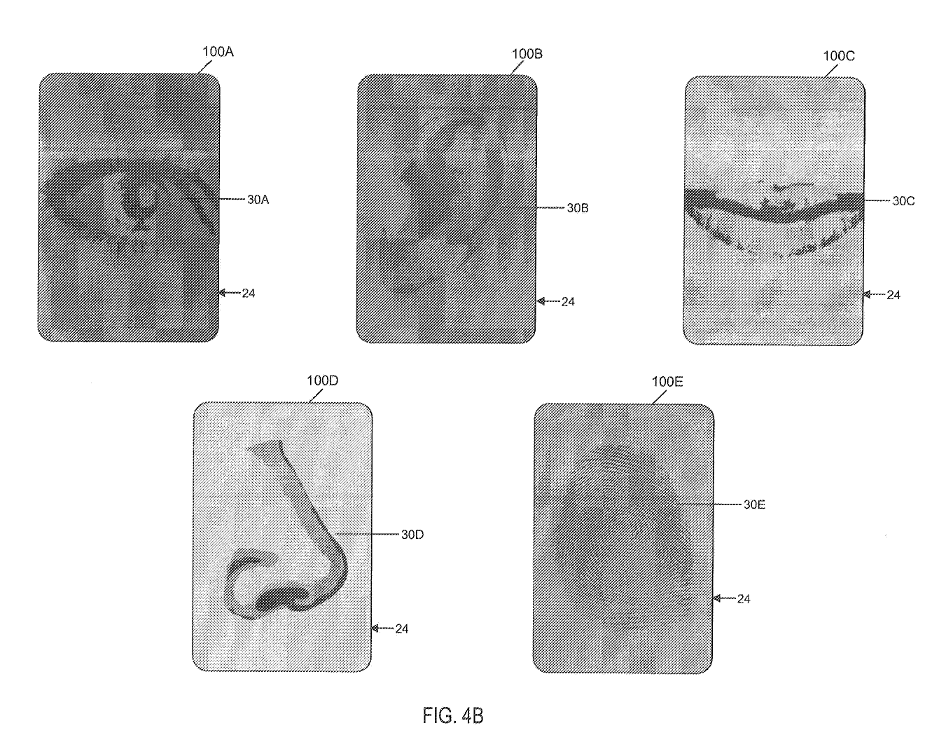

FIG. 4A shows exemplary identifier cards 100A-100E for each of sense subsets 12, 14, 16, 18, and 20. Front side 22 of first identifier card 100A includes specific indicia 26A, front side 22 of second identifier card 100B includes specific indicia 26B, front side 22 of third identifier card 100C includes specific indicia 26C, front side 22 of fourth identifier card 100D includes specific indicia 26D, and front side 22 of fifth identifier card 100E includes specific indicia 26E. Indicia 26A includes identifier “SIGHT” 28A and an image of a human eye 30A; indicia 26B includes identifier “SOUND” 28B and an image of a human ear 30B; indicia 26C includes identifier “TASTE” 28C and an image of a human mouth 30C; indicia 26D includes identifier “SCENT” 28D and an image of a human nose 30D; and indicia 26E includes identifier “TOUCH” 28E and an image of a human fingerprint 30E.

FIG. 4B shows exemplary rear views of identifier cards 100A-100E. In an exemplary embodiment, rear side 24 of identifier card 100A includes the image of a human eye 30A, rear side 24 of identifier card 100B includes the image of a human ear 30B, rear side 24 of identifier card 100C includes the image of a human mouth 30C, rear side 24 of identifier card 100D includes the image of a human nose 30D, and rear side 24 of identifier card 100E includes the image of a human fingerprint 30E.

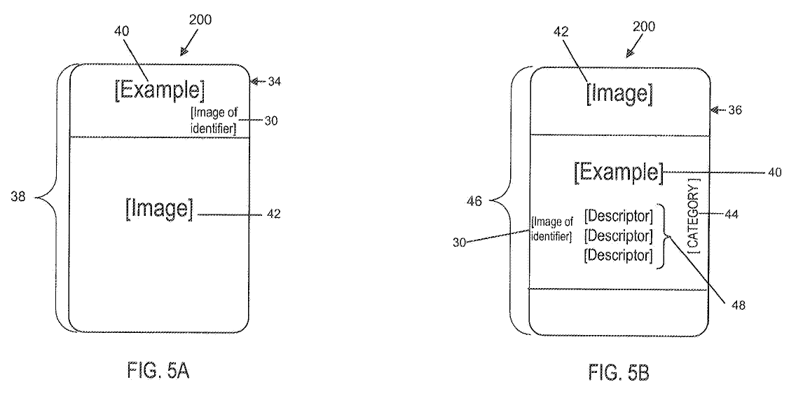

FIGS. 5A and 5B show a front view and a rear view of an exemplary descriptor card 200 and will be discussed in conjunction with one another. Each descriptor card 200 includes a front side 34 and a rear side 36. Front side 34 of descriptor card 200 includes a first set of indicia 38. First set of indicia 38 includes a word or phrase representing an example 40 of a theme category 44 (represented by a word or phrase), image 42 associated with example 40, and image 30 of the portion of the body that is associated with the human sense of the respective sense subset 12-20. Rear side 36 of descriptor card 200 includes a second set of indicia 46. Second set of indicia 46 includes theme category 44, example 40 of theme category 44, image 42 of example 40, descriptors 48 (represented by a word or phrase) associated with example 40, and image 30. Although FIG. 5B depicts second set of indicia 46 as including one example 40, one image 42, three descriptors 48, and image 30 of the portion of the body that is associated with the human sense, second set of indicia 46 may include any number of examples, images, and descriptors without departing from the intended scope of the present invention.

Theme categories 44 are directed to an architectural or design style and function to provide an analytical and emotional approach to determining the personality profile and revealing the brand essence of a business. Each of sense subsets 12, 14, 16, 18, and 20 include the same theme categories 44. In an exemplary embodiment, theme categories 44 include: Thematic, Tech, Contemporary, Retro, Modem, Whimsical, Transitional, Industrial, Casual, and Traditional, respectively. Example 40 and image 42 allow the user to focus on a particular element of the human sense so that the user can more readily extract the attributes that define the business (personality profile). Descriptors 48 define properties characteristic of example 40 and function as a reveal, focusing in on the personality profile of the business.

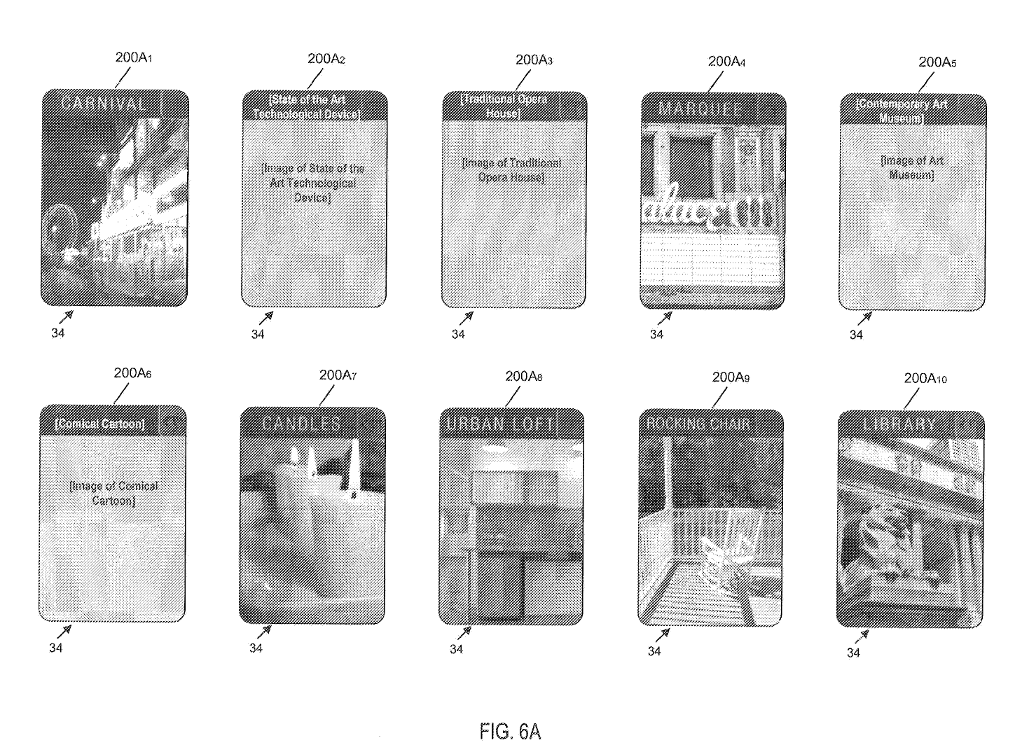

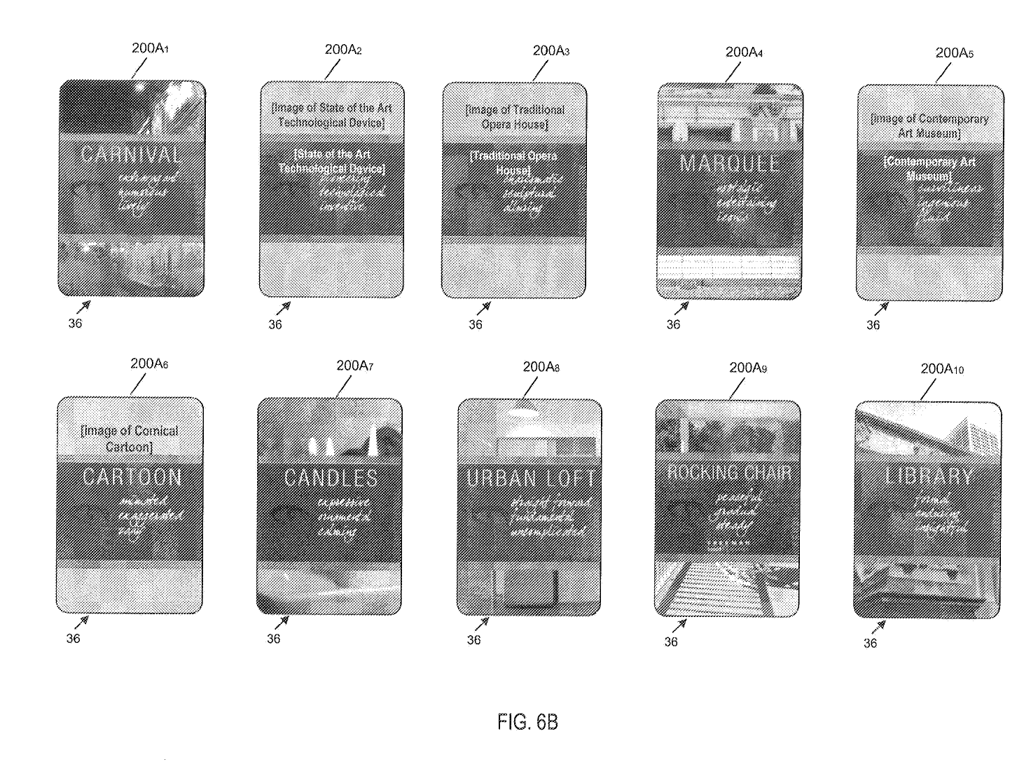

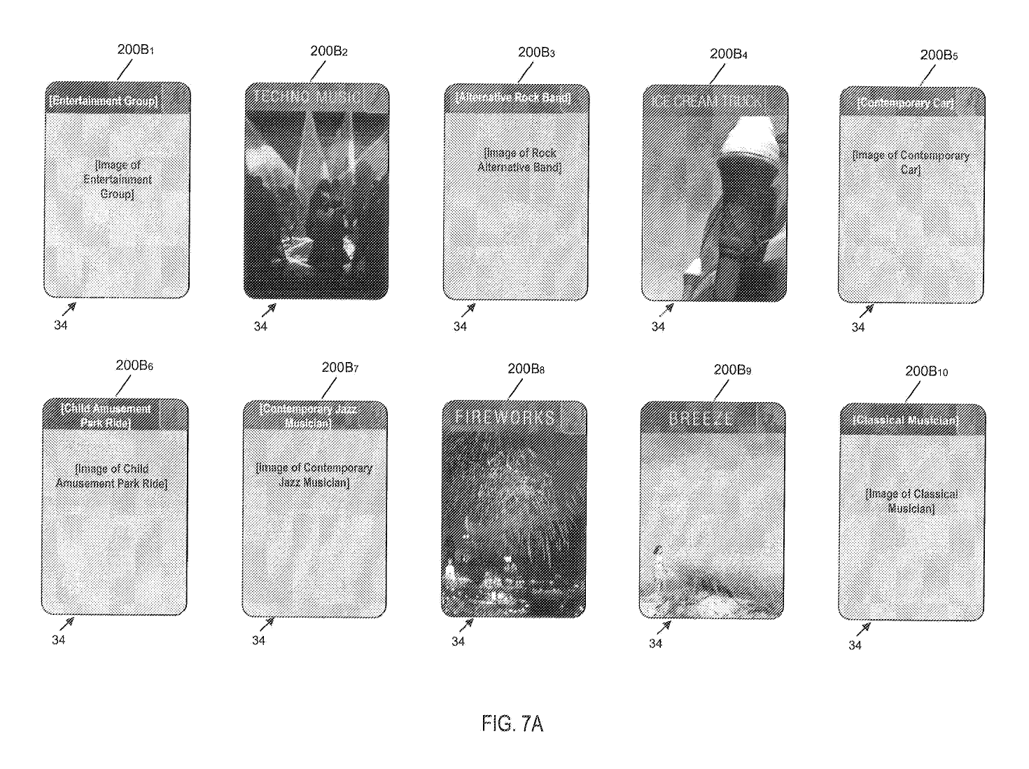

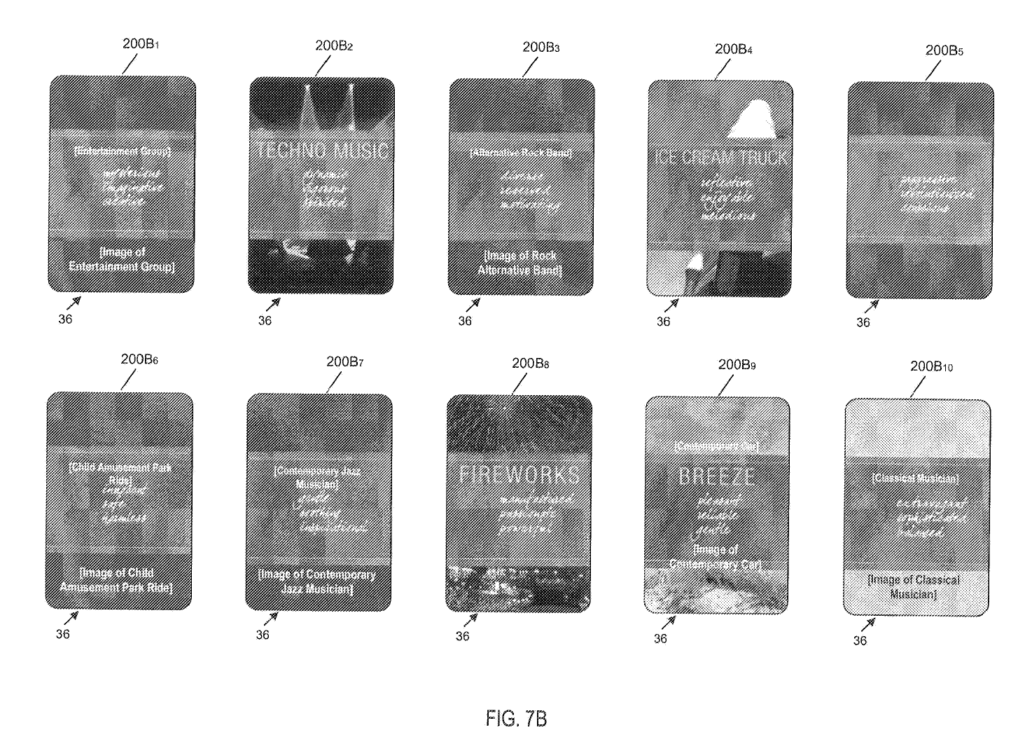

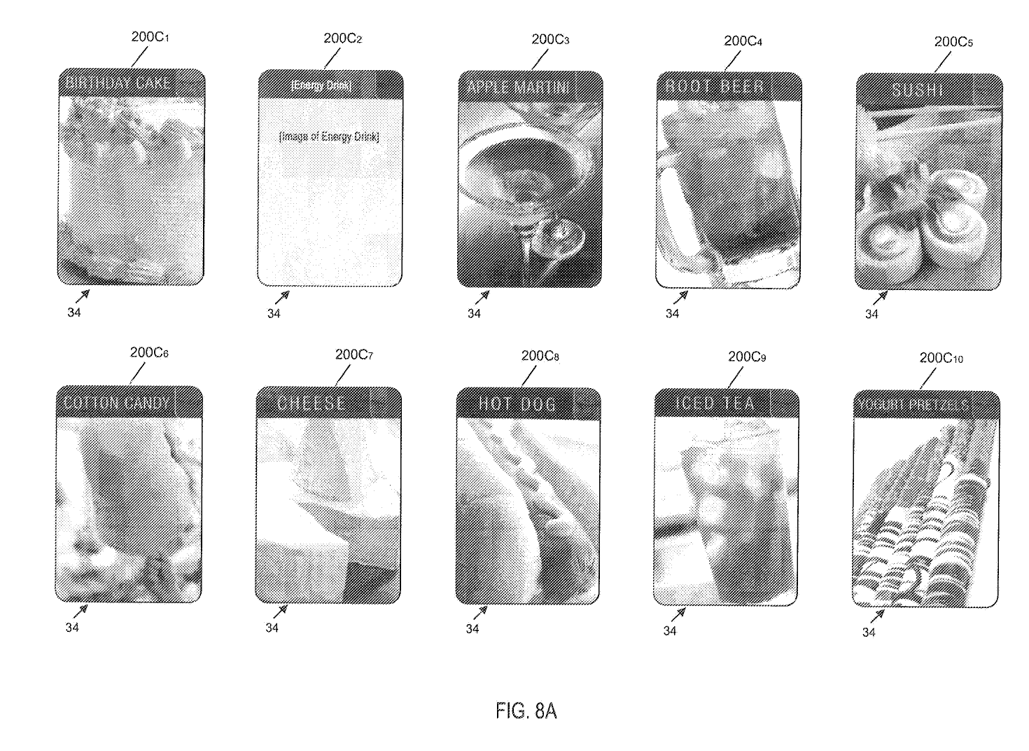

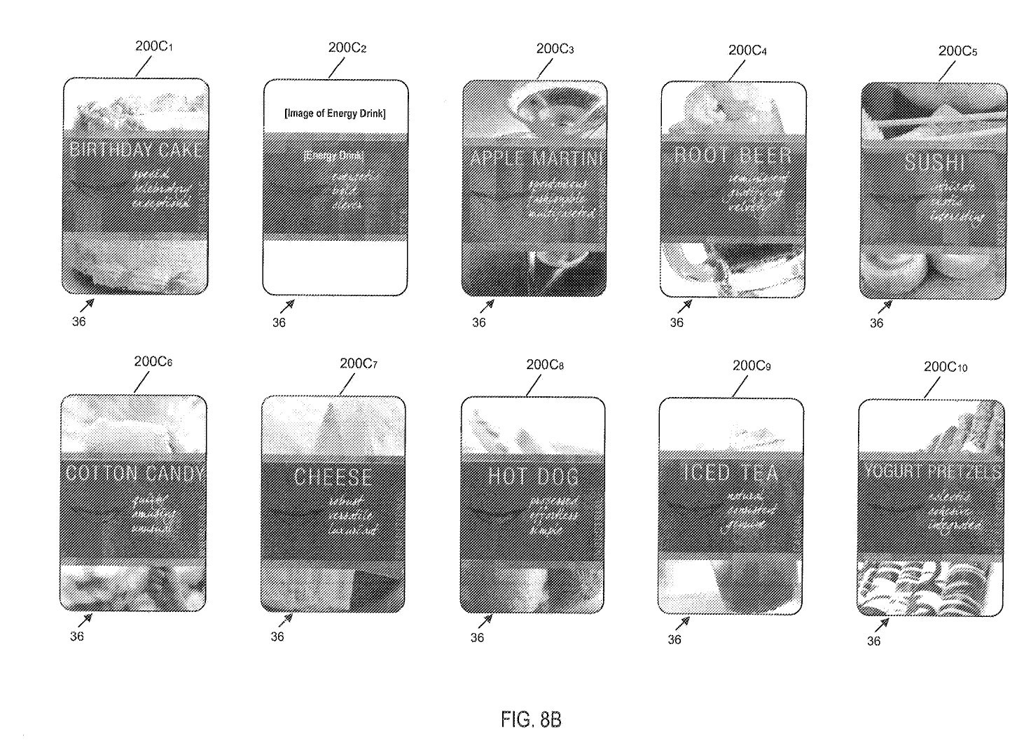

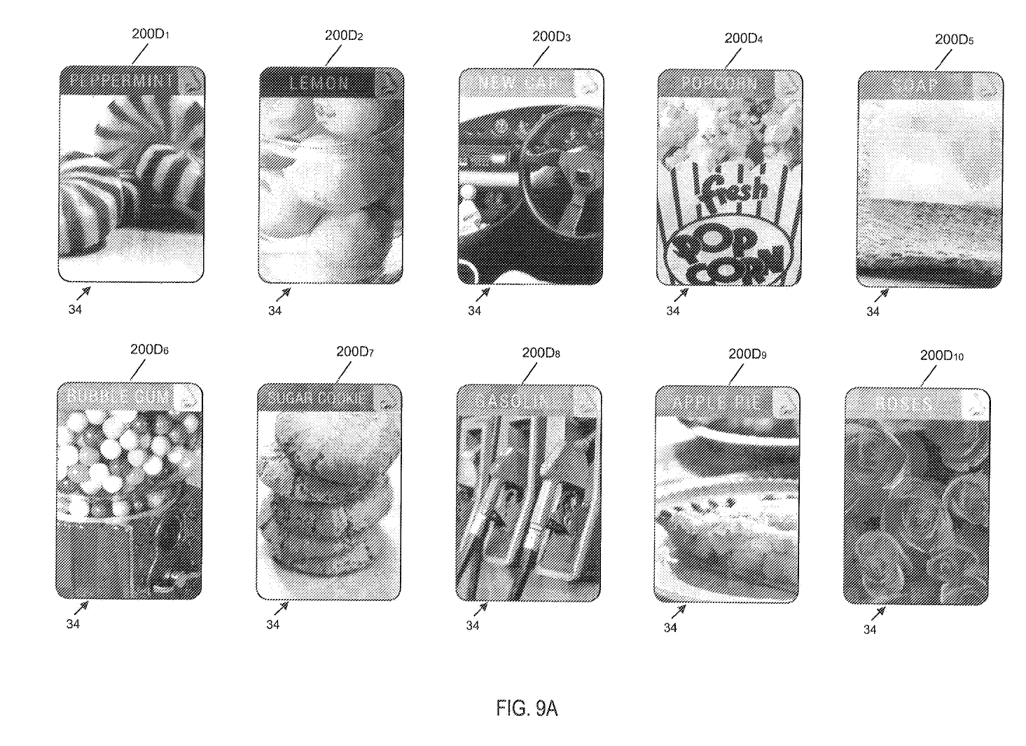

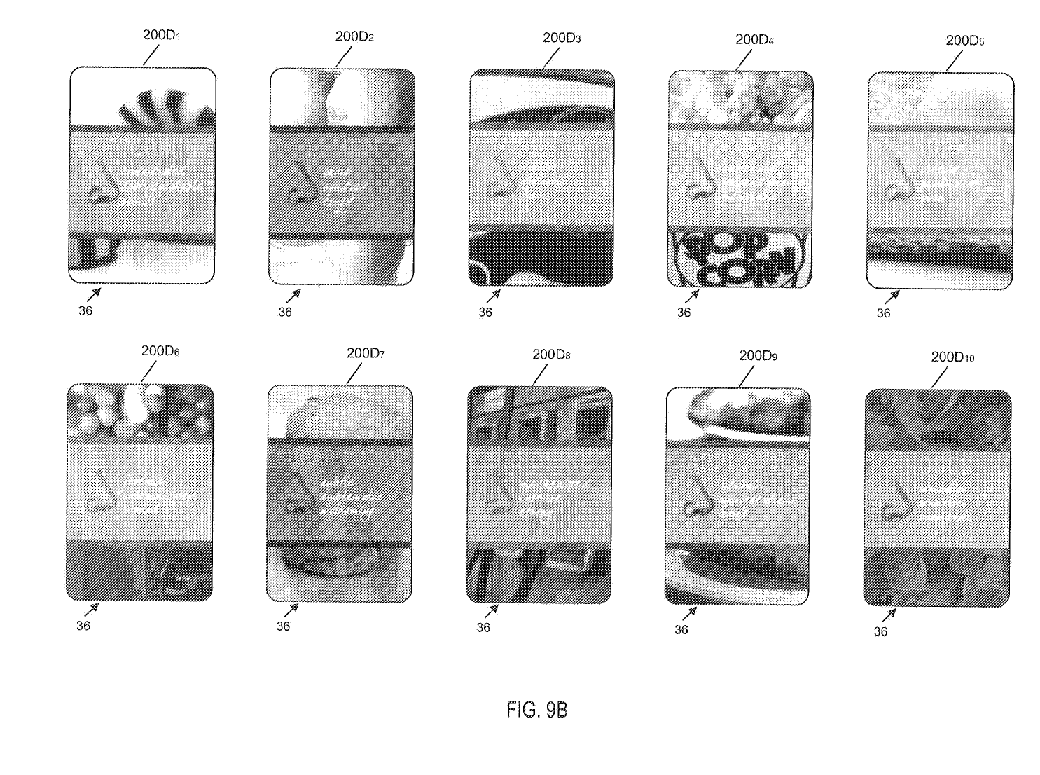

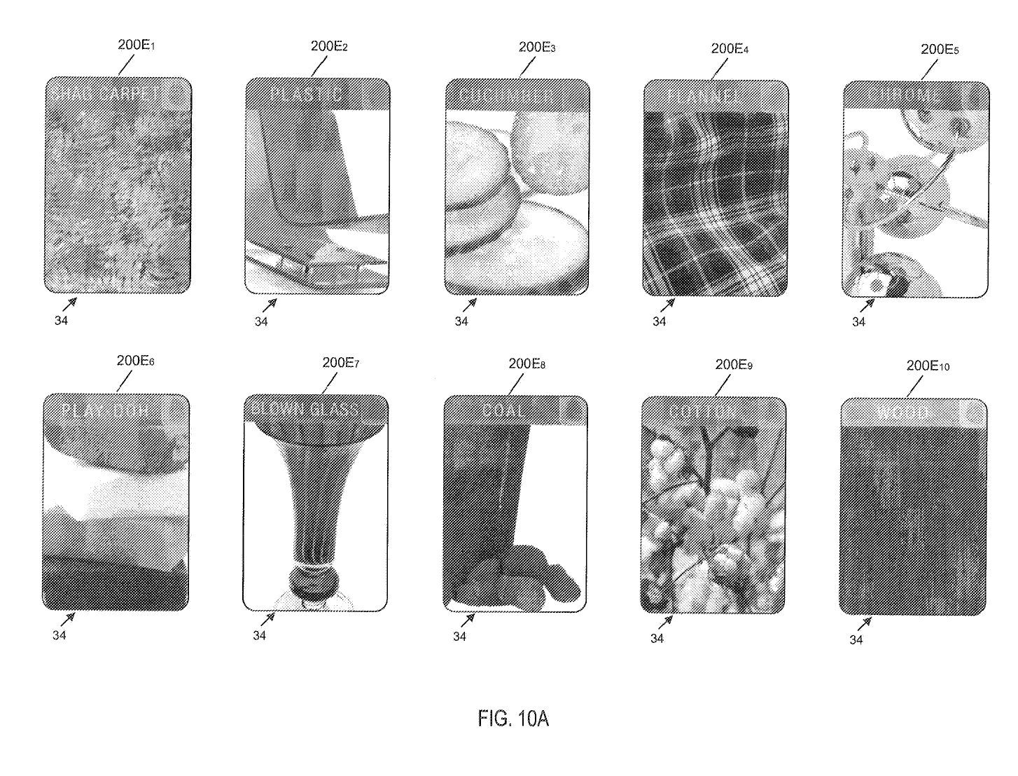

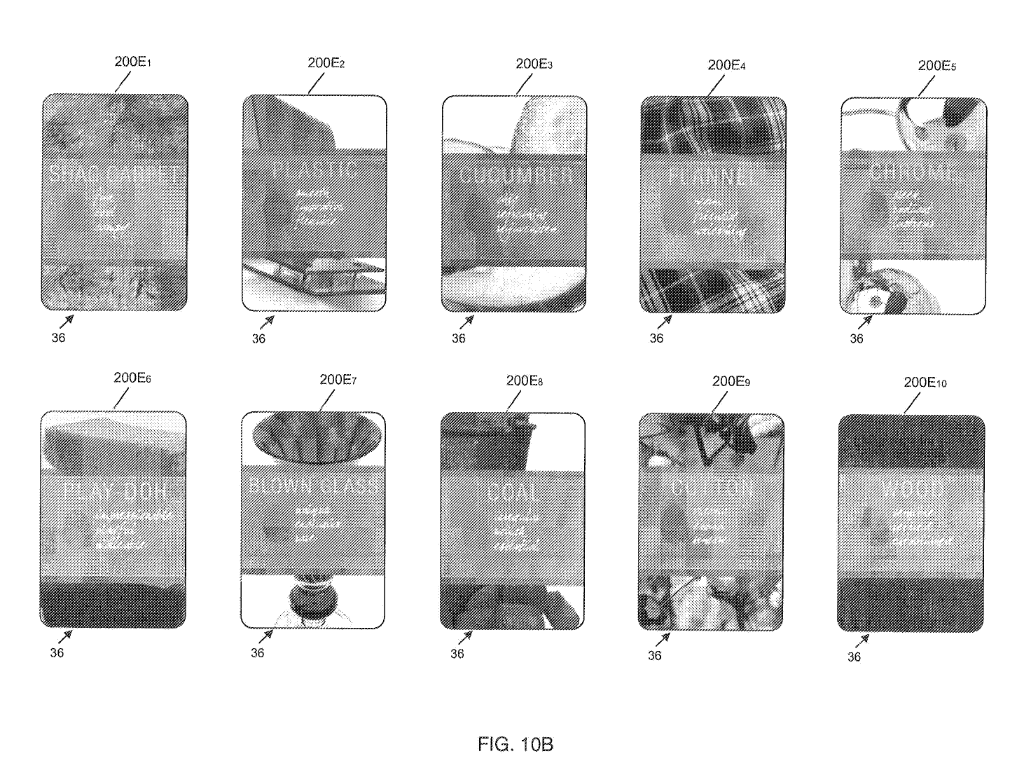

FIGS. 6A, 7A, 8A, 9A, and 10A show exemplary embodiments of front sides 34 of descriptor cards 200 of sense subsets 12, 14, 16, 18, and 20, respectively. FIGS. 6B, 7B, 7C, 8C, 9B, and 10B show exemplary embodiments of rear sides 36 of descriptor cards 200 of sense subsets 12, 14, 16, 18, and 20, respectively.

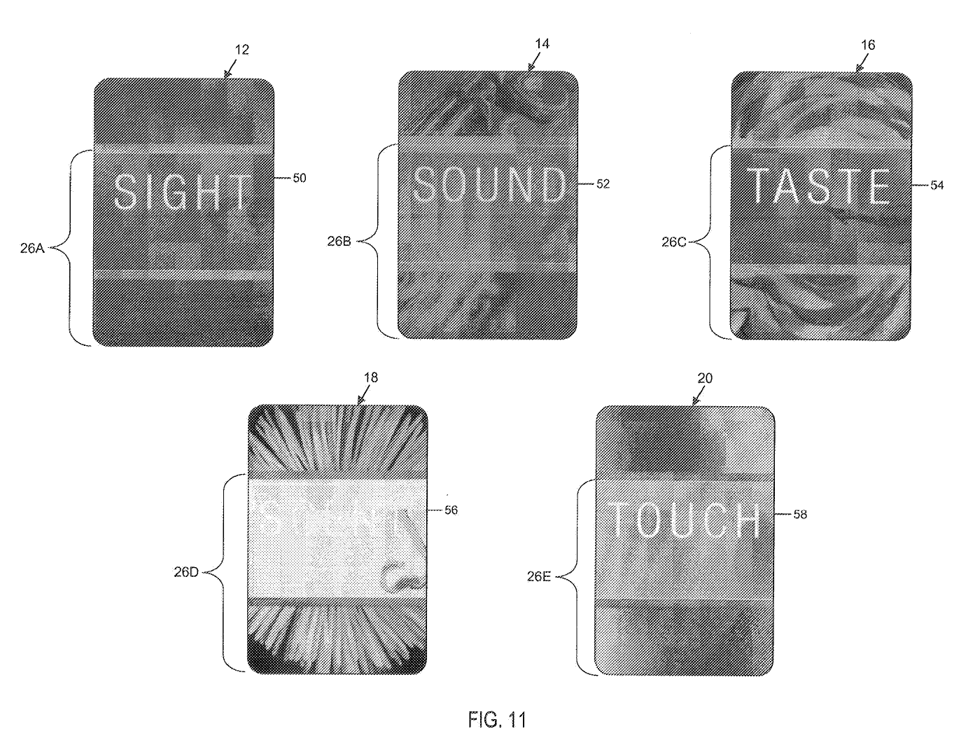

FIG. 11 shows a front view of exemplary embodiments of sense subsets 12-20, respectively, held together. Identifier card 100 and descriptor cards 200 (shown in FIGS. 3A, 3B, 5A, and 5B) of each of sense subsets 12, 14, 16, 18, and 20 can for convenience optionally be held together by a first, second, third, fourth, and fifth strap 50, 52, 54, 56, and 58, respectively, when set of sensory cards 10 is not being used. Each of straps 50-58 includes indicia 26 of the human sense associated with each respective sense subset 12-20. Indicia 26 on straps 50-58 are the same as indicia 26 on front side 22 of identifier cards 100 (shown in FIG. 4A). Although FIG. 11 depicts each sense subset 12-20 as being held together by straps 50-58, any means may be used to maintain each sense subset 12-20 together without departing from the intended scope of the present invention.

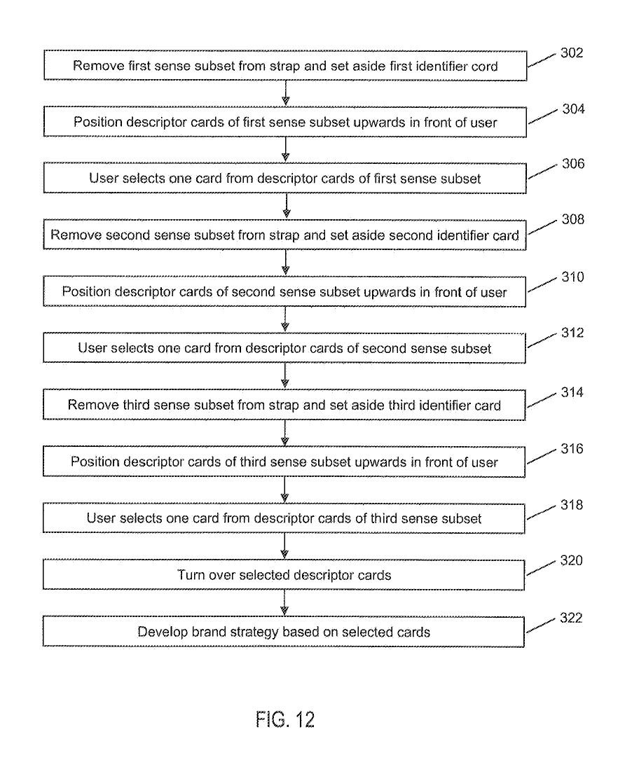

FIG. 12 is a flow diagram illustrating a method 300 of designing a brand strategy of a business using set of sensory cards 10. First sense subset 12 is first removed from strap 50 and identifier card 100A is set aside (Step 302). Descriptor cards 200A₁-200A₁₀ of first sense subset 12 are positioned in front of a user with front sides 34 of descriptor cards 200A₁-200A₁₀ facing upwards so that the user is only able to view image 30 associated with the portion of the body associated with the human sense, example 40, and image 42 (Step 304). Based on example 40 and image 42, the user selects one card 200A from descriptor cards 200A₁-200A₁₀ that best defines or characterizes the business (Step 306). Second sense subset 14 is then removed from strap 52 and identifier card 100B is set aside (Step 308). Descriptor cards 200B₁-200B₁₀ of second sense subset 14 are then positioned in front of the user with front sides 34 facing upwards (Step 310). As can be seen in Step 312, the user then selects one card 200B from descriptor cards 200B₁-200B₁₀ that best defines or characterizes the business. Next, third sense subset 16 is removed from strap 54 and identifier card 100C is set aside (Step 314). Descriptor cards 200C₁-200C₁₀ of third sense subset 16 are positioned in front of the user with front sides 34 of descriptor cards 200C₁-200C₁₀ facing upwards (Step 316). The user then selects one card 200C from descriptor cards 200C₁-200C₁₀ that best defines or characterizes the business that the user is representing (Step 318). This process may optionally be repeated with fourth and fifth sense subsets 18 and 20 such that one card 200A, 200B, 200C, 200D, and 200E is selected from each of first, second, third, fourth, and fifth sense subsets 12, 14, 16, 18, and 20, respectively. After a card 200A, 200B, 200C, 200D, and 200E has been selected from each of first, second, third, fourth, and fifth sense subsets 12, 14, 16, 18, and 20, selected cards 200A, 200B, 200C, 200D, and 200E are turned over so that rear sides 36 of cards 200A, 200B, 200C, 200D, and 200E are facing upwards (Step 320). In addition to image 30, example 40, and image 42, theme category 44 and descriptors 48 of selected cards 200A, 200B, 200C, 200D, and 200E are revealed to the user.

A brand strategy and brand style representing the brand essence of the business may then be developed based on selected cards 200A, 200B, 200C, 200D, and 200E (Step 322). Preferably, the brand strategy and brand style are developed based on selected cards 200A, 200B, 200C, 200D, and 200E as well as information about the business received during conversations with the user regarding the personality or essence that the business would like to portray to its consumers.

The tool and the method of developing a brand essence using the set of sensory cards of the present invention are based on the five human senses: sight, sound, taste, scent and touch. The set of sensory cards includes five sense subsets of cards, each of which is associated with one of the human senses. Each of the five sense subsets includes an identifier card and a plurality of descriptor cards. The descriptor cards include a first set of indicia on a front side of the cards and a second set of indicia on the rear side of the cards. The first set of indicia generally includes an example associated with a theme category and an image associated with the example. The second set of indicia includes a theme category directed to an architectural or design style, the example associated with the theme category and relating to the associated human sense, an image associated with the example, and descriptors associated with the example. In practice, each subset of cards is initially positioned so that the user can only view the first set of indicia. The user selects a card from each of the subsets of cards that best represents the business from each of the subsets of cards based on the first set of indicia. The selected cards are then turned over to reveal the second set of indicia. From the second set of indicia, a trend can be determined and a brand strategy or brand style can be developed that is based on all five of the human senses. While the method is discussed as developing a brand strategy based on all five of the human senses, a trend may also become apparent after at least three cards of fewer are selected.

Although the present invention has been described with reference to preferred embodiments, those skilled in the art will recognize that changes may be made in form and detail without departing from the spirit and scope of the invention.

1. A tool for use in connection with development of a brand essence comprising a plurality of subsets of descriptor cards having a first set of indicia relating to an associated human sense on a first side of the descriptor cards and a second set of indicia relating to the associated human sense on a second side of the descriptor cards, wherein the tool is based on a plurality of theme categories common to each subset of descriptor cards, wherein:
the first set of indicia on each descriptor card comprises:
a theme category;
at least one example associated with the theme category and relating to the associated human sense;
at least one descriptor associated with each example; and
at least one image associated with the example; and
the second set of indicia on each descriptor card comprises:
at least one example associated with the theme category of the first set of indicia and relating to the associated human sense; and
at least one image associated with the example.

2. The tool of claim 1, wherein each of the human senses is selected from the group consisting of: sight, taste, sound, scent, and touch.

3. The tool of claim 1, wherein each of the theme categories is selected from the group consisting of: thematic, tech, contemporary, retro, modem, whimsical, transitional, industrial, casual, and traditional.

4. The tool of claim 1, wherein each subset of descriptor cards further comprises an identifier card.

5. The tool of claim 1, and further comprising a means for maintaining each subset of descriptor cards together.

6. The tool of claim 4, wherein the means for maintaining each subset of descriptor cards together has a third set of indicia relating to the associated human sense.

7. The tool of claim 4, wherein the means for maintaining each subset of descriptor cards together comprises a strap.

8. The tool of claim 1, wherein the example of the first set of indicia and the example of the second set of indicia are the same.

9. The tool of claim 1, wherein the image of the first set of indicia and the image of the second set of indicia are the same.

10. A method for developing a brand strategy using the tool of claim 1, the method comprising:
providing the plurality of subsets of descriptor cards;
receiving a descriptor card from each of the plurality of subsets of descriptor cards, wherein each of the descriptor cards is selected based on the second set of indicia;
turning the selected descriptor cards over to reveal the first set of indicia
forming the brand strategy based on the first set of indicia of the selected descriptor cards.

11. A tool for developing a brand presentation, the tool comprising:
a first subset of descriptor cards having a first set of indicia relating to a first human sense on a first side of the descriptor cards and a second set of indicia relating to the first human sense on a second side of the descriptor cards, wherein the first human sense is sight;
a second subset of descriptor cards having a first set of indicia relating to a second human sense on a first side of the descriptor cards and a second set of indicia relating to the second human sense on a second side of the descriptor cards, wherein the second human sense is taste;
a third subset of descriptor cards having a first set of indicia relating to a third human sense on a first side of the descriptor cards and a second set of indicia relating to the third human sense on a second side of the descriptor cards, wherein the third human sense is sound;
a fourth subset of descriptor cards having a first set of indicia relating to a fourth human sense on a first side of the descriptor cards and a second set of indicia relating to the fourth human sense on a second side of the descriptor cards, wherein the fourth human sense is scent; and
a fifth subset of descriptor cards having a first set of indicia relating to a fifth human sense on a first side of the descriptor cards and a second set of indicia relating to the fifth human sense on a second side of the descriptor cards, wherein the fifth human sense is touch;
wherein each subset of descriptor cards comprises a set of theme categories, and wherein the set of theme categories is the same for each subset of descriptor cards; and
wherein the first set of indicia and the second set of indicia on each descriptor card comprises:
at least one example relating to an associated theme category and an associated human sense; and
at least one image associated with the example; and
wherein the second set of indicia on each descriptor card further comprises:
the theme category; and
at least one descriptor associated with each example.

12. The tool of claim 11, wherein each subset of cards further comprises an identifier card.

13. The tool of claim 11, and further comprising a means of maintaining each subset of descriptor cards together.

14. The tool of claim 13, wherein the means for maintaining each subset of descriptor cards together comprises a strap.

15. The tool of claim 11, wherein each of the theme categories is selected from the group consisting of: thematic, tech, contemporary, retro, modern, whimsical, transitional, industrial, casual, and traditional.

16. A method for developing a brand strategy using the tool of claim 11, the method comprising:
providing the first subset of descriptor cards, second subset of descriptor cards, third subset of descriptor cards, fourth subset of descriptor cards, and fifth subset of descriptor cards;
receiving a selected descriptor card from each of the first subset of descriptor cards, second subset of descriptor cards, third subset of descriptor cards, fourth subset of descriptor cards, and fifth subset of descriptor cards, wherein each of the descriptor cards is selected based on the first set of indicia;
turning over each of the selected descriptor cards to expose the second set of indicia; and
forming the brand strategy based on the second set of indicial of the selected descriptor cards.

17. A method for developing a brand strategy comprising:
providing a plurality of sets of descriptor cards, wherein each set of descriptor cards comprises a set of theme categories, wherein the set of theme categories is the same for each set of descriptor cards, and wherein each of the descriptor cards comprises a first set of indicia and a second set of indicia;
selecting a descriptor card from each set of descriptor cards based on the first set of indicia;
turning over the selected descriptor cards to expose the second set of indicia; and
forming the brand strategy based on the second set of indicia of the selected descriptor cards;
wherein the first set of indicia and the second set of indicia on each descriptor card comprises:
at least one example relating to an associated theme category and an associated human sense; and
at least one image associated with the example; and
wherein the second set of indicia on each descriptor card further comprises:
the theme category; and
at least one descriptor associated with each example.
